(19) United States
(12) Patent Application Publication
(10) Pub. No.: US 2025/0249819 A1
(43) Pub. Date: Aug. 7, 2025

(54) POP-UP ROOF FOR A RECREATIONAL VEHICLE

(71) Applicant: Thor Tech, Inc., Elkhart, IN (US)

(72) Inventors: Bernhard Sawetzki, Wolfegg (DE); Andre Jablonski, Eberhardzell (DE)

(73) Assignee: Thor Tech, Inc., Elkhart, IN (US)

(21) Appl. No.: 18/987,732

(22) Filed: Dec. 19, 2024

(30) Foreign Application Priority Data
Feb. 7, 2024 (DE) 102024103397.5

(51) Int. Cl. B60P 3/34; B60H 3/00; B60R 13/08

(52) U.S. Cl. CPC B60P 3/341; B60H 3/0071; B60R 13/0815

(57) ABSTRACT

The invention relates to a pop-up roof for a recreational vehicle, in which at least one electric surface heater, in particular a heating foil, is integrated. The pop-up roof is in particular a pop-up roof, and the electric surface heater can be arranged on an upper shell, lower shell or a side wall of the pop-up roof. The invention is also directed to a recreational vehicle comprising such a pop-up roof.

The invention relates to a pop-up roof for a recreational vehicle and to a recreational vehicle.

Recreational vehicles with a living area are known as motorhomes and as vehicle trailers in the form of caravans or camper trailers. Motorhomes are usually produced as semi-integrated motorhomes, fully integrated motorhomes or panel vans, also called camper vans. In camper vans, the cargo area of a small transporter is converted into a living area, wherein the outer skin of the cargo area is slightly modified, for example by adding windows and pop-up roofs. In semi-integrated mobile homes, a living area is built onto the chassis of a standard light truck, including the drive unit and driver's cab. In fully integrated mobile homes, the body of the driver's cab is also replaced by a superstructure so that the driver's cab is completely integrated into the living area. Caravans or camper trailers are built in a similar way on a trailer chassis.

Recreational vehicles are currently primarily heated with gas heaters, which heat air using a burner. The heated air is fed into the living area. However, these heaters are not very efficient and do not always provide optimal heating of the living area.

The use of electric surface heaters in recreational vehicles is generally known. DE 44 40 433 A1 describes a surface radiant heating element for heating the living areas of motorhomes. The heating element can be integrated into a wall or the ceiling of a room.

The object of the invention is to make the heating of recreational vehicles even more flexible and efficient. In addition, the heating of recreational vehicles should be designed in such a way that users feel particularly comfortable in the vehicle.

The invention achieves these objects with the features of claims 1 and 10. Advantageous embodiments are given in the sub-claims.

The invention provides a pop-up roof for a recreational vehicle, into which an electric surface heater, in particular a heating foil, is integrated.

An electric surface heater is an electrically operated heater which converts electricity directly into heat, in particular infrared heat. An electric surface heater typically comprises at least one heating conductor, which converts electricity into infrared heat. Electric surface heaters are therefore also called infrared heaters or electric resistance heaters. In particular, the electric surface heater can be a heating foil. In a heating foil, the heating conductors are typically applied as a coating on a carrier material layer, e.g., made of plastics material or glass fibers. These elements are usually covered by a thin insulating layer, e.g., made of plastics film. Heating foils are available in various designs and sizes, e.g., as prefabricated individual parts or sold by the meter. Heating foils, for example, can have a thickness of 1-4 mm.

A “pop-up roof” is understood here to be a construction on a recreational vehicle with a pop-up roof, wherein the pop-up roof accommodates a sleeping area. The pop-up roof typically comprises a pop-up roof with what is known as an “upper shell,” which can be folded up to create the sleeping area, and a “lower shell,” which is approximately at the roof height of the recreational vehicle and on which a sleeping pad such as a mattress can be placed. The sleeping area is typically formed by folding out the pop-up roof with the upper shell, wherein the side walls, which are made, for example, from various tent tarpaulins, unfold. A pop-up roof is not only understood to mean the roof element which can be raised (referred to here as a pop-up roof), but also any elements which form a sleeping space or sleeping area on the roof of a recreational vehicle and which are accessible, for example, through a hatch from the interior of the recreational vehicle. On the other hand, a pop-up roof does not mean a roof tent, which is also located on the roof of a vehicle but is not directly accessible from the vehicle interior.

When folded up, the pop-up roof is accessible from the vehicle interior, e.g., through an opening in the lower shell. The pop-up roof can also have the additional function of increasing the standing height of the living space. This is in particular possible at the opening between the vehicle interior and the sleeping area. However, there are also recreational vehicles in which the space created by the pop-up roof can be used either for sleeping or to increase the standing height. Pop-up roof and pop-up roof are often used as synonyms.

Such pop-up roofs are not heated in the current prior art, as they are only used for sleeping and have a relatively small volume, so that it has not previously been sensible to direct the heated air up into this sleeping area. Laying electrical cables in a pop-up roof is also not ideal due to the mobility of the pop-up roof.

The invention is based on the realization that electric surface heaters allow particularly flexible, easily adjustable and at the same time maximally—up to 100%—efficient heating of a pop-up roof. The electric surface heaters can be integrated in one or more places in the lower shell, the lying surface, the side walls or the upper shell/ceiling of the pop-up roof and provide pleasant warmth there. The air flow which is essential for air heating or convection heating and often perceived by the occupants as an unpleasant draft is eliminated.

The recreational vehicle can be a motorhome, in particular a camper van, a semi-integrated or fully integrated motorhome, or a caravan.

In one embodiment, the electric surface heater is arranged on an upper shell of the pop-up roof. Here, the term “upper shell” refers in particular to the hinged upper part of the pop-up roof. The upper shell, in turn, can have a multi-layer structure and comprise an outer skin, an inner insulation layer, and a lining layer toward the interior of the sleeping area. Embodiments without an insulation layer and lining are also conceivable. The advantage of arranging the electric surface heater on the upper shell of the pop-up roof is that the infrared radiation from above creates a particularly pleasant sleeping climate. In addition, the upper shell is very large and therefore allows the surface heater to be arranged over a large area of more than 0.5 m², e.g., over 0.5 to 3.5 m², preferably over 1-3 m², more preferably over 1-2 m². The heat radiated from above by the surface heater is perceived as pleasant and can also be put to good use when the sleeping area is used as a lounge area or when the pop-up roof is used to increase the standing height.

According to another embodiment, an electric surface heater is alternatively or additionally arranged on a lying surface of the pop-up roof and in particular arranged on a lower shell of the pop-up roof or integrated into the lower shell. This embodiment has the advantage that the heating power is used particularly efficiently when sleeping, as it is generated directly on the lying surface. The surface heater can be switched on shortly before going to bed to provide a preheated bed. The surface heater can be arranged in a lower shell of the pop-up roof, for example glued thereto. The lower shell is the element of the pop-up roof which forms its underside and thus creates the lying surface. The lower shell can serve as a support or adapter for a mattress or other sleeping surface. The lower shell can have one or more layers. Like the upper shell, it is typically adapted to the shape of the recreational vehicle.

According to yet another embodiment, an electric surface heater is alternatively or additionally arranged on a side wall of the pop-up roof. It can also be integrated into a side wall. This embodiment can be used for side walls which are made like a tent from one or more films. In this embodiment, a heat radiation-reflecting layer or film is advantageously provided between the surface heater and an outer tent tarpaulin of the side wall of the tent roof. However, the side wall can also be an inflatable side wall, wherein the surface heater can then be applied to or even integrated into an inflatable element of the side wall.

According to an advantageous embodiment, the electric surface heater is integrated into an upper shell and/or a lower shell of the pop-up roof. This means in particular that the surface heater is permanently installed in the upper shell and/or the lower shell of the pop-up roof and has not been retrofitted, e.g., by being subsequently glued on. In particular, the surface heater can be inseparably connected to the upper shell and/or the lower shell of the pop-up roof. Preferably, the electric surface heater is not visible or not completely visible, but is covered, for example, with a textile layer. In some embodiments, the electric surface heater is integrated into a sandwich component, wherein a cover layer of the sandwich structure runs between the surface heater and the interior. This means that the electric surface heater can be integrated into the pop-up roof in a virtually invisible way. Preferably, the electric surface heater extends over more than 20%, preferably more than 80%, of the area of the upper shell and/or lower shell of the pop-up roof; particularly preferably it extends over the entire area of the upper shell and/or lower shell of the pop-up roof.

According to one embodiment, the upper shell and/or the lower shell of the pop-up roof is made from lightweight materials, e.g., a plastics material, a fiber-reinforced plastics material, in particular a glass fiber-reinforced plastics material (GRP) or a light metal such as an aluminum alloy. Preferably, the upper shell and/or the lower shell of the pop-up roof is a molded part, i.e., a generally flat element, the shape of which is adapted to its position and function in the living space. Such molded parts for the construction of living spaces for recreational vehicles are produced, for example, by extrusion.

According to one embodiment, the upper shell and/or the lower shell of the pop-up roof can be a composite element, in particular a composite of plastics material and fibers. For example, the upper shell and/or the lower shell of the pop-up roof can be produced using LFI processes. LFI stands for long-fiber-injection. Glass fibers are typically used as reinforcing fibers, and polyurethane (PUR) is preferably used as the matrix material. In the LFI production process, the fibers are pulled from a roll during the process and cut into individual fibers in a cutting machine. The individual fibers are mixed with liquid plastics material in an LFI mixing head and fed into the mold of a press tool. In particular, the mixing head is moved over the mold by an industrial robot to distribute the plastics material fiber mixture. The plastics material fiber mixture is then pressed under pressure in the tool. Natural fibers can also be processed as an alternative to glass fibers. According to one embodiment of the invention, a surface heater, in particular a heating foil, is inserted into the press before pressing. The heating foil can be used before or after adding the liquid plastics material fiber mixture.

According to one embodiment, the upper shell and/or the lower shell of the pop-up roof can be constructed in multiple layers. The upper shell advantageously has a dimensionally stable outer skin and an insulation layer underneath. The insulation layer can be covered toward the interior. The outer skin and optionally the lining can be designed as extruded parts. According to one embodiment, the upper shell and/or the lower shell can be produced, for example, in a mold and back-foamed with an insulation material. The insulation material can, for example, be a polyurethane (PUR) foam or a particle foam.

According to one embodiment, the upper shell and/or the lower shell of the pop-up roof comprises at least one supporting layer and optionally a further layer, wherein the electric surface heater is inseparably connected to at least one of the layers. The electric surface heater can also form a layer of the upper shell and/or lower shell of the pop-up roof. The supporting layer can be a layer of fiber-reinforced plastics material, e.g., GRP, or a layer of aluminum sheet, or a plastics material layer, e.g., a plastics material plate or a plastics material shell produced by extrusion, in particular vacuum deep drawing. The supporting layer can be made of acrylonitrile butadiene styrene (ABS), for example. The additional layer can be, for example, an insulation material layer or a lining. The upper shell and/or the lower shell of the pop-up roof can comprise further layers, for example a further supporting layer, a reflective layer and/or a lining layer. This embodiment can be used particularly advantageously for the upper shell.

Preferably, the electric surface heater is inseparably connected to at least one of the layers and thus integrated into the upper shell and/or the lower shell of the pop-up roof. The connection can be made by foaming, welding or gluing, for example. In an adhesive bond, an activator can advantageously be used to accelerate the curing of the adhesive. This is particularly advantageous if the electric surface heater is attached to a foamed surface. Preferably, the surface heater is fully bonded to the upper shell and/or lower shell. Alternatively, the connection can also be made by other integral bonding processes, for example by welding, in particular plastics welding. For example, the surface heater can be welded onto a plastics material layer of the upper shell and/or lower shell of the pop-up roof, especially if it contains a plastics material which is difficult to bond, such as polyethylene or polypropylene. The welding connection can be made by means of hot element welding, infrared welding, laser beam welding, ultrasonic welding or vibration welding.

According to one embodiment, the upper shell and/or the lower shell of the pop-up roof comprises at least one supporting layer and one insulation material layer, wherein the electric surface heater is embedded in the insulation material layer or applied thereto. The insulation material layer is in particular a foamed layer, in particular made of foamed plastics material. Suitable materials for the insulation material layer include PUR, expanded polyethylene (EPP) or polystyrene. Fiber-reinforced heat-insulating plastics materials are also advantageously used as insulation materials because as they also offer high mechanical stability. This embodiment can be used particularly advantageously for the upper shell.

According to a further embodiment, the insulation material layer is applied in two layers, wherein the electric surface heater is embedded between the two layers. In yet another embodiment, the electric surface heater is applied to the insulation material layer after it has been produced and connected thereto. A further supporting layer, e.g., a covering layer made of fiber-reinforced plastics material, can then be applied. The electric surface heater can be connected to the insulation material layer, for example by gluing or welding.

In order to strengthen the connection of the electric surface heater with the insulation material layer, the surface heater preferably has at least one, in particular a plurality of recesses. These can be depressions such as grooves or perforations such as holes into which an adhesive or an insulation material can penetrate, so that the electric surface heater is held in a form-fitting manner to the insulation material layer or another layer of the upper shell and/or lower shell of the pop-up roof. According to a particularly preferred embodiment, the recesses are openings. In the region of the recesses, the surface heater can thus be penetrated by adhesive or by the material of one of the layers of the upper shell and/or lower shell and can thus be integrated particularly firmly into the upper shell and/or the lower shell of the pop-up roof.

According to one embodiment, the upper shell and/or the lower shell of the pop-up roof has a layer which reflects heat radiation, in particular a metal foil. This is advantageously arranged between the electric surface heater and an outside of the recreational vehicle in order to reflect the heat radiation inward into the living area. It is advantageously positioned directly under the surface heater. This results in the following advantageous structure of the upper shell from outside to inside: Outer skin (supporting layer), insulation layer, optional reflective layer, electric surface heater, optional lining. The following advantageous structure results from bottom to top for the lower shell: Supporting layer, optional insulation layer, optional reflective layer, electric surface heater, optional lining. The lining is advantageously a textile lining, e.g., made of fleece, felt or fabric. The lining can also be made of plastics material and can in particular be an extruded part.

According to one embodiment, the upper shell of the pop-up roof is preferably made of an outer shell made of GRP, plastics material or metal, into which an insulation material layer is foamed. For example, foaming can be done in two steps: after foaming a first layer, a heating foil is inserted and then a second layer is foamed on top. Alternatively, the heating foil is applied after foaming and bonded to the insulation material layer, in particular glued or welded, as described above. According to an advantageous embodiment, the upper shell and/or the lower shell of the pop-up roof comprises at least one supporting layer which is made of an aluminum alloy. Advantageously, the aluminum layer in the upper shell forms the outer skin of the recreational vehicle. On the inside, the aluminum layer can simultaneously perform the function of the reflective layer. Alternatively, in this embodiment, an insulating or reflective foil can also be arranged between the outer supporting layer and the surface heater.

According to one embodiment, the electric surface heater comprises a heatable textile, in particular a sheet-like textile such as a woven fabric, knitted fabric, fleece and/or felt. This has the advantage that the electric surface heater can simultaneously form the inner lining of the sleeping area in the pop-up roof, in particular the inner lining of the upper shell and/or lower shell. Heatable textiles are known in the prior art and are used to produce electrically heated clothing. In addition to the textile threads, heatable textiles also have electrically conductive threads which run through the textiles at intervals and can be connected to a voltage source. The advantage of heated textiles compared to heating foil is, on the one hand, the attractive exterior, which makes additional lining on the interior unnecessary, and, on the other hand, they provide a pleasant feeling of space. For example, it is possible to cover the upper side of the base shell and thus the lying surface of the sleeping area with heated textiles. In another embodiment, the pop-up roof is equipped with a mattress which is covered with heated textiles or is integrated into the heated textile. This means that the heat source is placed particularly close to the occupant, and the bedroom can be heated particularly efficiently. This results in the following structure from top to bottom for the upper shell: Outer skin, insulation layer, optional reflective layer, layer of heatable textiles. The following advantageous structure results for the lower shell from bottom to top: Supporting layer, optional insulation layer, optional reflective layer, layer of heatable textiles.

According to an advantageous embodiment, the electrical connection of the electric surface heater is arranged in the region of the pivotable mounting of the upper shell of the pop-up roof. The electrical connection cables of the surface heater are typically led out of one edge of the upper shell and/or lower shell and connected to the power supply of the recreational vehicle. The electric surface heater can advantageously be operated both by the on-board electrical system with low voltage, for example, 12 V or 24 V DC, as well as by 230 V mains power via an appropriate power supply unit if the recreational vehicle is connected to the power grid. A major advantage of electric surface heater is that it can also be operated at low voltages of less than 50 V. In advantageous embodiments, it is provided that the surface heater can be operated at different mains frequencies, in particular at frequencies between 40 Hz and 70 Hz, preferably between 47 Hz and 63 Hz, because the mains frequencies can vary in different countries, e.g., 50 Hz in Europe and 60 Hz in North America. The power supply is preferably a switching power supply, which is suitable for use with different mains voltages (e.g., 85255 V) and frequencies or even DC, and converts these to a constant output voltage.

According to an advantageous embodiment, the electric surface heater can be controlled digitally, in particular via an app and/or via a central on-board computer. The electric surface heater is advantageously connected to a network and can be controlled remotely via the Internet, e.g., it can be switched on while on the move. A corresponding app for controlling the electric surface heater can be installed on the user's smartphone, for example. The app can be controlled via an on-board computer, in particular a Smart Caravan Unit (SCU), for example; communication preferably takes place via the Internet.

If the electric surface heater is integrated into the upper shell of the pop-up roof, the electrical connection cables are preferably routed into the interior in the region of the pop-up mechanism in order to then be connected to the on-board electrical system. The pop-up mechanism includes, for example, telescopic rods and/or a pivotable mounting of the upper shell.

Advantageously, the electric surface heater extends over 10-100%, preferably 20-60% of the area of the upper shell and/or the lower shell of the pop-up roof. This allows for particularly pleasant heating of the pop-up roof.

The invention is also directed to a recreational vehicle, in particular a camper van, a semi-integrated motorhome, a fully integrated motorhome or a caravan, which has at least one pop-up roof with an integrated surface heater.

The invention will now be described in more detail with reference to the accompanying drawings. In the drawings:

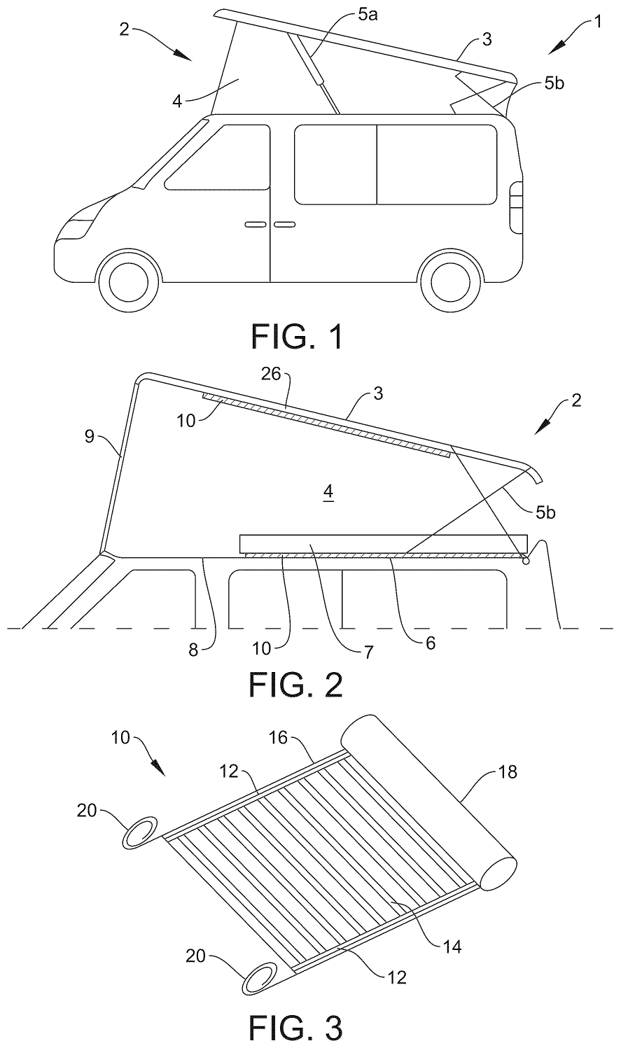

FIG. 1 shows a camper van according to an embodiment of the invention;

FIG. 2 shows a pop-up roof according to an embodiment of the invention;

FIG. 3: is a perspective view of a heating foil according to an embodiment of the invention;

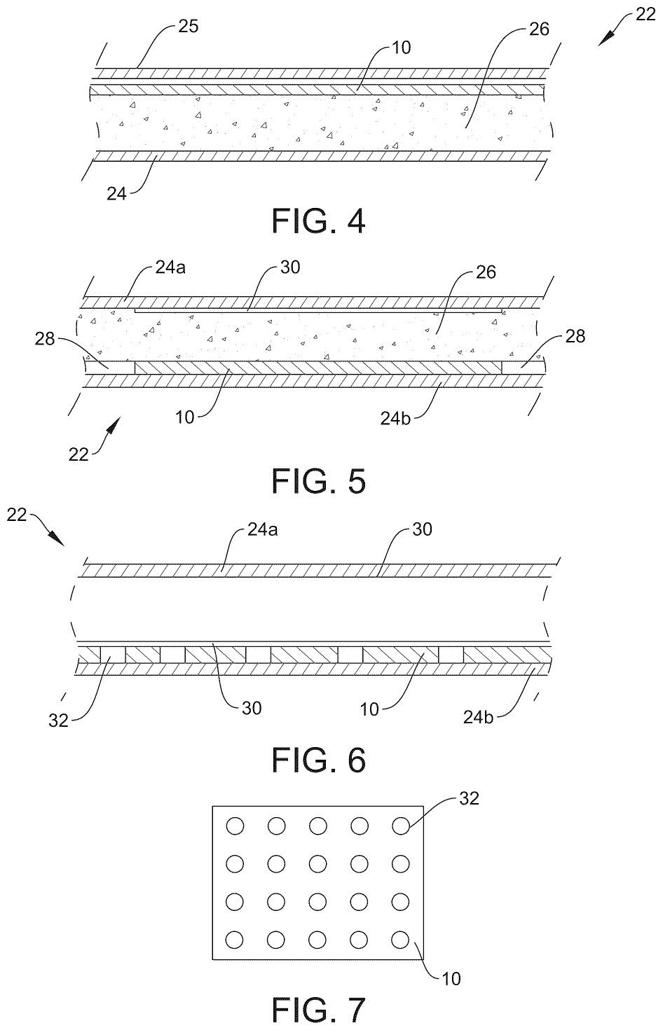

FIG. 4 shows a schematic cross section through an upper shell or lower shell in sandwich construction according to a first embodiment of the invention;

FIG. 5 shows a schematic cross section through an upper shell or lower shell in sandwich construction according to a second embodiment of the invention;

FIG. 6 shows a schematic cross section through an upper shell or lower shell in sandwich construction according to a third embodiment of the invention;

FIG. 7 is a plan view of a heating foil according to an embodiment of the invention;

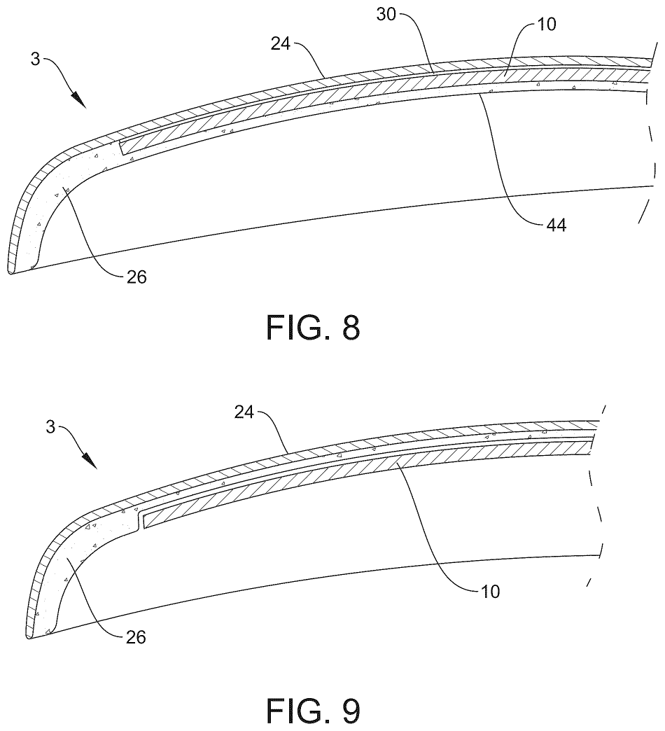

FIG. 8 shows a schematic cross section through a roof shell according to an embodiment of the invention;

FIG. 9 shows a schematic cross section through a roof shell according to an embodiment of the invention.

Identical elements are identified by identical reference signs in the figures.

FIG. 1 is a schematic side view of a camper van 1 with a pop-up roof 2. The pop-up roof 2 comprises the pop-up roof with an upper shell 3, which can be folded up by means of the pop-up mechanism in the form of telescopic rods 5a and a pivotable mounting 5b in order to form the sleeping area/bedroom 4 underneath. An electric surface heater is integrated into the upper shell 3 of the pop-up roof 2.

FIG. 2 shows the pop-up roof 2 in a schematic cross section. In addition to the upper shell 3 and the pivotable mounting 5b, FIG. 2 also shows a side wall 9 of the pop-up roof 2. In this case, it is made up of an external rainproof film and an internal mosquito net. In addition, the lower shell 6 is also shown, which limits the sleeping area at the bottom and forms a support surface for a mattress 7. At 8 there is a passage to the living area of the camper van, which can be reached via a ladder (not shown). According to one embodiment of the invention, an electric surface heater 10 is integrated into the upper shell 3. Additionally or alternatively, an electric surface heater 10 can also be arranged underneath the mattress 7.

FIG. 3 shows an example of an electric surface heater 10, which can be integrated into a pop-up roof for recreational vehicles. In this embodiment, the surface heater is a heating foil 10 in which an electrically conductive coating 12, 14 is applied to a carrier material 16 and welded into a plastics film. The heating conductors 14 generating infrared radiation run, for example, between two copper strips 12. The copper strips 12 are connected to the electrical power supply by means of the lines 20. In this embodiment, the surface heater 10 is flexible and can thus be rolled up into a roll 18 for transport purposes. It can also be installed on curved surfaces, as is necessary for some molded parts in recreational vehicles.

FIG. 4 shows a schematic cross section through a molded part 22 with a multi-layer structure which can form an upper shell and/or lower shell of a pop-up roof 2, in particular an upper shell. The molded part has a supporting layer (e.g., the outer skin of the upper shell) 24 made of fiber-reinforced plastics material or metal, to which an insulation material layer 26 is applied. The surface heater 10 is applied to the insulation material layer 26, e.g., glued on by an adhesive with an activator. The surface heater 10 extends over the entire width of the upper shell 22 and thus forms a separate layer thereof. The surface heater 10 is covered with a lining 25, e.g., a fleece or felt material. In the drawing, the interior of the vehicle is located above the molded part 22.

FIG. 5 shows another embodiment of an upper shell and/or lower shell 22 of a pop-up roof 2 with a sandwich structure. This has two supporting layers 24a, 24b made of fiber-reinforced plastics material or metal, between which an insulation material layer 26, in particular in the form of a rigid foam plate, is arranged. A reflective layer 30 is attached to the outer cover layer 24a, while the heating foil 10 is attached to the inner cover layer 24b. This embodiment has the advantage that the heating foil 10 is closer to the interior to be heated.

According to a further embodiment shown in FIG. 6, the reflective layer 30 is applied directly to the heating foil 10. The heating foil 10 is connected, e.g., glued, to the inner cover layer 24b. In many embodiments, it is advantageous if the heating foil has openings 32 which can be penetrated by foam material or adhesive in order to ensure secure fastening of the heating foil 10. FIG. 7 is an exemplary plan view of such a heating foil 10, in which openings 32 in the form of round through-holes are arranged at regular intervals. The openings 32 can also be seen in FIG. 6.

As can be seen in FIG. 4-6, the heating foil 10 extends over the entire surface of the upper shell or lower shell 22, but it can also take up only part of the surface.

FIG. 8 shows a schematic cross section through an upper shell 3 of a pop-up roof according to an embodiment of the invention. This has an outer skin 24, which forms a supporting layer. This can be made of GRP or aluminum, for example. In the example shown, a reflective foil 30 is glued to the outer skin 24 and the heating foil 10 is applied thereto. In particular, the heating foil 10 can be attached to the reflective foil 30 during production by gluing or welding. The insulation material 26 is applied as a further layer to the heating foil, in particular foamed in. Toward the interior, the insulation material layer 26 can be provided with a textile lining 44.

FIG. 9 shows another embodiment of the upper shell 24. Here, the insulation material layer 26 has a recess into which a surface heater is inserted in order to achieve a flat surface toward the interior. If necessary, a reflective layer 30 can be arranged behind the surface heater 10; this function can optionally also be performed by the outer skin 42. Here, too, an additional textile lining (not shown) can be provided. Alternatively, the surface heater is designed as a heatable textile, which does not require any additional lining.

1. Pop-up roof for a recreational vehicle, wherein at least one electric surface heater, in particular a heating foil, is integrated.

2. Pop-up roof according to claim 1, wherein an electric surface heater is arranged on an upper shell of the pop-up roof and in particular is integrated into the upper shell.

3. Pop-up roof according to claim 1, wherein an electric surface heater is arranged on a lying surface of the pop-up roof and in particular is arranged on a lower shell of the pop-up roof or is integrated into the lower shell.

4. Pop-up roof according to claim 1, wherein an electric surface heater is arranged on a side wall of the pop-up roof.

5. Pop-up roof according to claim 1, wherein the upper shell and/or the lower shell of the pop-up roof comprises at least one supporting layer and an optional further layer, wherein the electric surface heater is inseparably connected to at least one of the layers.

6. Pop-up roof according to claim 1, wherein the upper shell and/or the lower shell of the pop-up roof comprises at least a supporting layer and an insulation material layer, wherein the electric surface heater is embedded in the insulation material layer or applied thereto.

7. Pop-up roof according to claim 1, wherein the electric surface heater, in particular heating foil, has at least one, preferably a plurality of recesses.

8. Pop-up roof according to claim 1, wherein the electric surface heater comprises a heatable textile, in particular a sheet-like textile such as a woven fabric, knitted fabric, fleece and/or felt.

9. Pop-up roof according to claim 1, wherein the electrical connection of the electric surface heater is arranged in the region of the pivotable mounting of the upper shell of the pop-up roof.

10. Recreational vehicle comprising a pop-up roof according to claim 1.
